(19) United States
(12) Patent Application Publication
(10) Pub. No.: US 2011/0171592 A1
(43) Pub. Date: Jul. 14, 2011

(54) Method of Direct Fabrication of Intraoral Devices

(76) Inventor: Elsa Wittbold, Ormond Beach, FL (US)

(21) Appl. No.: 13/119,181

(22) PCT Filed: Sep. 30, 2009
(86) PCT No.: PCT/US09/59106

§ 371 Date: Mar. 15, 2011

Related U.S. Application Data
(60) Provisional application No. 61/101,536, filed on Sep. 30, 2008.
(60) Provisional application No. 61/207,443, filed on Feb. 11, 2009.

(51) Int. Cl. A61C 9/00

(52) U.S. Cl. 433/37

(57) ABSTRACT

A method of direct fabrication of intraoral devices provides an easy, cost effective way of making a variety of appliances intraorally. The use of a thin layer of unset plastic or thermoplastic material on a flexible tray allows for a customized fit to any palate, directly in the oral cavity. A palatal retainer provides the primary retention for optional functional components to be incorporated. Functional components may include anterior deprogrammers, and full coverage and partial coverage occlusal guards. Use of the palatal retainer provides comfortable, safe retention without the need for excessive facial wrap. The retainer itself can function as a palatal obturator or a healing stent. Fabrication of the appliances could be performed by the end user, health care providers, or anyone skilled in the art.

### CROSS-REFERENCE TO RELATED APPLICATIONS

This application claims the benefit under 35 U.S.C. §119(e) of U.S. Provisional Patent Application No. 61/101,536, filed Sep. 30, 2008, and U.S. Provisional Patent Application No. 61/207,443, filed Feb. 11, 2009, which applications are incorporated herein by reference in their entireties.

### BACKGROUND

1. Technical Field

The present disclosure relates generally to intraoral devices and, more specifically, to the method of direct intraoral fabrication of a palatal retainer onto which a variety of functional components can be incorporated.

2. Description of the Related Art

Many people suffer from the consequences of clenching and grinding their teeth (bruxism). Tension headaches, migraine headaches, myofascial pain, broken teeth, worn down teeth, and gum recession have all been attributed to the effects of clenching and grinding one's teeth.

Several oral devices have been developed over the years to help people keep their teeth separated during the sleeping hours and during stressful daytime hours. These devices fall into two general categories:

Those designed to only contact the front incisors, thus preventing the back teeth and canines from touching each other are known as anterior deprogrammers, anterior discluders, intraoral discluders, and anterior bite planes.

Those designed to cover all or most of the chewing surfaces to keep the teeth from touching each other are known as full occlusal splints or occlusal guards.

If an appliance is customized, it is either made on plaster models of the user's mouth (indirect) or it is customized on the user (direct). Because this disclosure specifically deals direct fabrication of appliances on the user, prior art that relates to direct fabrication or direct customization will be addressed.

### Anterior Deprogrammers

Tension and muscle contraction headaches affect many people every day. The headaches are often recurring due to strained and fatigued muscles of jaw closure. Pain from a cramping temporalis muscle is quite severe and is often diagnosed as “common” migraine. The temporalis is recruited when canines contact each other or another surface. For this reason, full coverage occlusal guards and don't offer headache relief to the degree that anterior deprogrammers do.

The lateral pterygoid muscle is another muscle involved with jaw closure. It is the one most frequently involved with myofascial pain and temporomandibular joint (TMJ) related pain. Since it is the positional muscle, lateral interferences and posterior occlusal discrepancies always activate the lateral pterygoid. As with any muscle, over-activation results in fatigue and pain. This pain often gives the impression of a TMJ disorder. A high percentage of the misdiagnosed TMJ disorders are muscle disorders that are readily resolvable.

Anterior deprogrammers employ the use of a discluding element (DE). The DE is a platform positioned on the front teeth designed to keep all of the posterior teeth from touching when the mouth is closed. By doing this, anterior deprogrammers eliminate the trigger for muscle activity and provide nearly 100% tension relief of all the muscles of closure. If there are no disorders in the TMJ capsule itself, an anterior deprogrammer is extremely effective in reducing the painful symptoms in the head and neck area. They are so effective that an increasing number of dentists use anterior deprogrammers as a key tool in the differential diagnosis and treatment of TMJ pain, headaches, and myofascial pain. Anterior deprogrammers are also used as a permanent appliance for the suppression of clenching and grinding, and the prevention of resulting symptoms.

There are many designs that implement the concept of the anterior deprogrammers. Devices made directly on the user are desirable because they can be made in one appointment and at a lower cost. However, they have several disadvantages.

They are small devices covering only the anterior incisor teeth. Thus, the most serious disadvantage of these devices is the risk of swallowing the device or aspirating it. Some include a method of attaching a string to the device to insure retrieval if the device becomes lodged in the user's throat. The Consumer Products Safety Commission guideline for a choking hazard is an object under 1.75 inches in diameter. Even in its thickest form, U.S. Pat. No. 6,666,212 has a diameter of no more than 0.75 inch.

Also, they are retained by snapping onto the upper or lower front teeth, which puts the entire bite load solely on those few teeth. There have been reports of forward flaring of teeth due to such unsupported forces.

With the only retention coming from the front (facial) and back (lingual) walls of the incisor teeth, the facial wall is relative large and unsightly. This unsightliness bears a negative effect on user compliance.

Because they are made of a hard acrylic shell that is lined on the patient's front teeth, a dentist is needed to adjust the bite.

Although the small, direct-made devices have the advantage of no laboratory bill, and no second delivery appointment, many dentists prefer to use appliances made indirectly on models of the user. By attaching the DE to a larger retentive element such as a palatal retainer, the above mentioned disadvantages are addressed.

The retainer is usually larger than the opening to the back of the throat and poses no risk of swallowing or choking on the device.

The retainer distributes some of the biting force off of the incisors and onto the adjacent teeth and hard palate, reducing the risk of forward flaring of the incisors.

Because retention is enhanced by the retainer, the facial wall of the device can be minimized or eliminated for a more cosmetic appliance. This promotes user compliance.

Because the laboratory customizes the bite, minimal or no bite adjustment is required upon delivery.

### Full Occlusal Guards

Most full occlusal devices are fitted by a dentist and involve a laboratory expense, resulting in higher cost to the dentist and consequently to the user. There are several affordable occlusal guards that are sold over-the-counter for users to fit on themselves. Most employ some sort of trough or channel that is lined with a resilient thermoplastic material that is molded to the tops and both sides of the teeth. Due to the depth that the teeth are embedded in the lining material, it needs to be resilient in nature in order to prevent being locked onto the teeth once set. To achieve the “one size fits all,” the trough must be wide enough for all teeth sizes. The width, combined with the fact that trough walls need to be on both sides of the teeth for adequate retention, makes these types of occlusal guard bulky and unsightly. Studies show that the springiness of the resilient guards can actually promote an increase in nocturnal chewing activity, defeating the quest to rest the jaw muscles.

Some user-made guards are more streamlined, but retention is very limited, and most users report difficulty keeping them in place. The preferred dentist-made occlusal guard is termed a permissive splint. This type of splint provides a smooth, flat biting surface covering all of the teeth on one arch. The smoothness allows the lower jaw to move around without any interference, allowing all chewing muscles to relax. None of the current direct made occlusal guards successfully provide this design.

U.S. Pat. No. 3,924,638 and U.S. Pat. No. 3,967,379 offer an alternative to the trough-style retention for direct made devices by using the palate surface to provide retention; however neither offers options for additional functional components. Also, there is no provision for the lining material to function as a standalone customized appliance. U.S. Pat. No. 3,967,379 limits its use to function as an orthodontic Hawley appliance.

### Partial Coverage Occlusal Guards

In an effort to make user-made occlusal guards less bulky, there are guards that only cover some of the back teeth. Retention is limited and the instability and springiness of the bite pads can actually promote chewing activity.

Dentists rarely provide partial coverage occlusal guards to treat symptoms of clenching and grinding. However, some guards marketed to improve athletic performance require a laboratory made appliance. Once again, the cost of a dental appointment and a laboratory made appliance are prohibitive to many patients.

### BRIEF SUMMARY

The present disclosure provides a method of incorporating many functional designs for upper appliances into a device that is comfortable, functional, and affordable. This is achieved by incorporating a functional component onto a retentive palatal retainer that is fabricated directly on the user's palate. The overall concept is based on adapting a flexible tray, lined with a high-flow material, to the palate until the material sets.

Most high-flow materials are sticky to the touch and have a tendency to droop. For this reason, a majority of direct-made appliances utilize a trough style tray that fits over the teeth. One advantage of the present disclosure is the utilization of a flexible tray that will adapt to any palatal shape. Pre-forming a flexible sheet onto a generic model of an upper arch with a functional component in place produces a tray into which functional components to be constructed and incorporated to the retainer at the time of fabrication.

In some cases, the tray material will become laminated to the lining material and become the outer layer of the finished appliance. The use of a standard size tray/shell is practical and possible due to the fact that the average width and height of most human adult palates has a variation of approximately +/−5 mm, which is well within range of the design provided.

There are several approaches. Some involve using a vinyl shell lined with a thermoplastic material. A thermoplastic material is ideal, especially for user-made appliances, because modifications are easily done by simply reheating the material. Also, the thickness of the lining material is controlled in the manufacturing process and is not dependent on the skill of the person making the appliance. Chemical setting materials that harden to a semi-rigid state would also be appropriate.

To generalize:

A method of fabrication involves positioning the functional component, e.g. a discluding element for an anterior deprogrammer, onto a upper arch model; vacuum forming a sheet of flexible material over said model to form a tray that incorporates the shape of the functional component; lining the tray with approximately 1-1.5 mm thickness of thermoplastic material that softens at 140-170° F., and filling the imprint of the functional component with additional thermoplastic material.

The method of customization involves heating the tray or plastic unit or both until the plastic is molten; correctly positioning the unit in the user's mouth; user adapting the unit with fingers and tongue to roof of mouth and sides of teeth; user applying functional movements as directed for individual appliance; user supporting the tray unit with their tongue until plastic returns to a hardened state; removing unit from mouth; removing tray; trimming excess plastic from edges of appliance; and reheating as needed to make adjustments and to smooth edges.

In accordance with the one embodiment of the present disclosure, a method of fabricating an intraoral discluder device for fitting to the upper palate and corresponding teeth of the upper palate is provided. The method includes forming a tray intraorally to cover the upper palate and the teeth of the upper arch; placing pliable thermoplastic on the tray; adapting intraorally the pliable thermoplastic in the tray to the upper palate; allowing the thermoplastic material to harden; trimming the hardened thermoplastic material of posterior biting surfaces; and adding a discluding element to the lingual side of the central incisors.

In accordance with another aspect of the present disclosure, the method includes adding the discluding element to the lingual side of the central incisors and the user forming the discluding element with the user's tongue.

In accordance with another embodiment of the present disclosure, the method includes, following trimming of the hardened thermoplastic material, reheating and adapting the trimmed thermoplastic material to fit the upper palate and lingual surface of the upper teeth.

In accordance with another embodiment of the present disclosure, the method includes wrapping a portion of the discluding element to a front surface of the anterior teeth for retention.

In accordance with another embodiment of the present disclosure, the fabrication method includes: (1) selecting and customizing a flexible tray to cover the upper palate and teeth; (2) heating a thermoplastic material, placing it on the tray, then adapting it to the upper palate; (3) trimming the hardened material of all posterior biting surfaces; and (4) adding a discluding element to the lingual (tongue side) surfaces of the central incisors.

In accordance with another embodiment of the present disclosure, a corresponding device or appliance is provided that includes a hardened thermoplastic palatal component and a discluding element formed thereon that is shaped by a user's tongue to match the user's profile.

In accordance with another embodiment of the present disclosure, a method of intraoral fabrication of a palatal appliance is provided that enables addition of functional components to the appliance.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 illustrates a sheet of flexible material used to make the tray;

FIG. 2 illustrates the cutting of the foam tray;

FIG. 3 illustrates placement of the tray and thermoplastic material in the mouth of the user;

FIGS. 4A-4B illustrate the cutting and formation of the trimmed palatal component;

FIG. 5 illustrates the addition of the discluding element to the palatal component;

FIG. 6 illustrates the completed appliance as viewed from the tongue;

FIG. 7 illustrates the completed appliance as viewed from the side;

FIGS. 8A-8C illustrate different embodiments of the discluding element;

FIG. 9 is a side view of the appliance held in place in a user's mouth, demonstrating effective separation of the back teeth;

FIG. 10 illustrates an alternative embodiment of a tray and blank formed in accordance with the present disclosure;

FIGS. 11-14 illustrate another embodiment of a night guard or orthodontic retainer formed in accordance with the present disclosure;

FIGS. 15-20A and 20B illustrate a one-step anterior deprogrammer formed in accordance with another embodiment of the present disclosure;

FIGS. 21-24 illustrate a two-step anterior deprogrammer formed in accordance with a further embodiment of the present disclosure;

FIGS. 25A-25F illustrate various discluding element embodiments formed in accordance with the present disclosure;

FIGS. 26A-26B through FIG. 30A-30B illustrate a method of fabrication of a discluding element in accordance with one embodiment of the present disclosure;

FIG. 31 illustrates placement of bite stops with respect to a user's teeth;

FIG. 32 illustrates placement of the unit in the user's mouth;

FIG. 33 illustrates a modification of the foregoing embodiment;

FIG. 34 illustrates a full contact permissive guard and only cusp tips contacting only the biting surface of the splint;

FIGS. 35-39 illustrate various aspects of a full contact permissive guard formed in accordance with the present disclosure;

FIGS. 40-43 illustrate various views of partial coverage occlusal guards and customized variations thereof; and

FIG. 44 illustrates a surgical healing stent appliance formed in accordance with the present disclosure.

### DETAILED DESCRIPTION

Further aspects of the system and method will become apparent from consideration of the drawings and the ensuing description of preferred embodiments of the disclosure. A person skilled in the art will realize that other embodiments of the disclosure are possible and that the details of the apparatus can be modified in a number of respects, all without departing from the scope of the disclosure. Thus, the following drawings and description are to be regarded as illustrative in nature and not restrictive.

In the following description, certain specific details are set forth in order to provide a thorough understanding of various embodiments of the disclosure. However, one skilled in the art will understand that the disclosure may be practiced without these specific details. In other instances, well-known structures associated with trays, discluders, and well-known aspects of human anatomy, particularly the palate and teeth, the jaw, and muscles related thereto have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The following description of the several embodiment(s) is merely exemplary in nature and is in no way intended to limit the disclosure, its application, or uses.

The following embodiments of the present disclosure provide for a custom made intraoral anterior discluder device and method for direct intraoral fabrication. More particularly, in one embodiment a method for making an anterior discluder is provided that is simple to make and affordable. It requires no additional retentive wires and offers a variety of discluding elements to meet a variety of needs. The present disclosure, which is retained by fitting on the palate, is far less bulky and provides full closure of the lips as opposed to previous designs. The device is made directly in the oral cavity and requires no dental lab procedure. At the time of fabrication, the user can customize the angle of disclusion to correspond to the angle that the TMJ moves downward/forward.

The method of forming the device in accordance with one embodiment of the present disclosure will now be described in conjunction with FIGS. 1-7 and FIGS. 8A-8C.

As shown in FIG. 1, a foam sheet 10 is used to form a tray. The foam sheet is readily commercially available and will not be described in detail herein. Briefly, the foam sheet 10 is preferably formed of a 2 mm foam sheet that can be obtained from craft stores. Alternatively, other forms of material can also be used, such as non-porous paper or thin plastic that gives support, but is flexible enough to adapt to the palate.

Prior to placement in the mouth, the foam sheet 10 is prepared as follows: Cut to a size that is small enough to fit into the mouth and large enough to cover the outsides of the back teeth and the front teeth. As shown in FIG. 1, the foam sheet 10 has a half-circle body portion 13 with a distal end 15 forming a straight line or slightly concave line and the opposing proximal end forming the handle 12 that extends outward from the body portion 13. Ideally the handle 12 is sized and shaped to enable a user to grasp the handle portion 12 with at least a thumb and forefinger. Although use of the handle 12 is shown in this embodiment, it is to be understood that the user can use their hands or fingers to place the sheet 10 in their mouth.

Accordingly, after preparation the foam sheet 10 is placed by the user in the user's mouth, preferably with the handle 12 in front of the two front teeth and centered between the front two teeth. The sheet should be positioned such that it covers the front and back teeth.

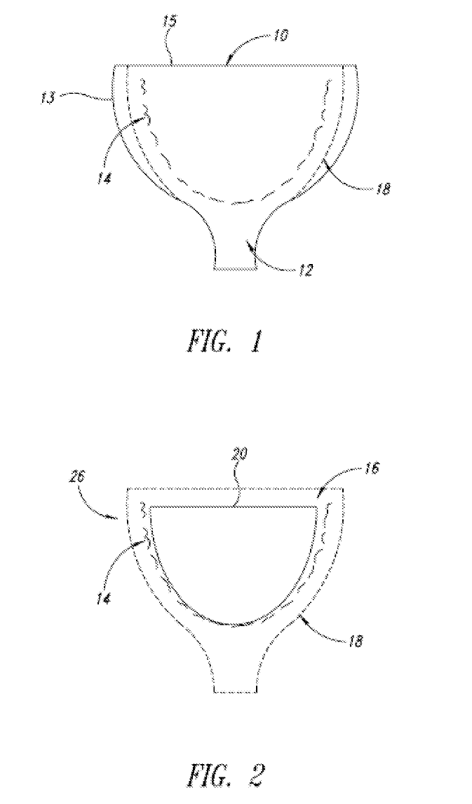

The user then bites into the foam sheet 10 to make bite marks 14 on the sheet 10 as shown in FIG. 2.

The foam sheet 10 is then removed from the mouth and cut approximately ¼ inch to the outside of the bite marks 14 along dotted line 18, as shown in FIG. 2, leaving the handle 12 intact, thus making a custom foam tray 16 from the foam sheet 10.

Next, a sheet of thermoplastic material is prepared for use with the custom foam tray 16. The thermoplastic material is preferably formed from Polycaprolactone (PCL). It is FDA approved for use in the human body and is also approved for the filling of root canals. This material is readily commercially available in bead form. An appropriate sheet can be made by placing approximately one tablespoon of the beads in hot water, allowing them to turn clear and pliable, molding them into a ball that can then be flattened into a sheet approximately 1-2 mm thick.

In order to prepare the thermoplastic material for use with the custom foam tray, it must be heated to change from a rigid solid state to a more pliable state. Ideally, the thermoplastic material is placed in hot water that is at approximately 160° F. until the material changes from being opaque to being clear, which indicates that it is now pliable. The excess softened material is trimmed off with scissors or other cutting instrument so that it covers the custom tray 16 just inside the bite marks 14 as shown in FIG. 2 to form a thermoplastic layer 20.

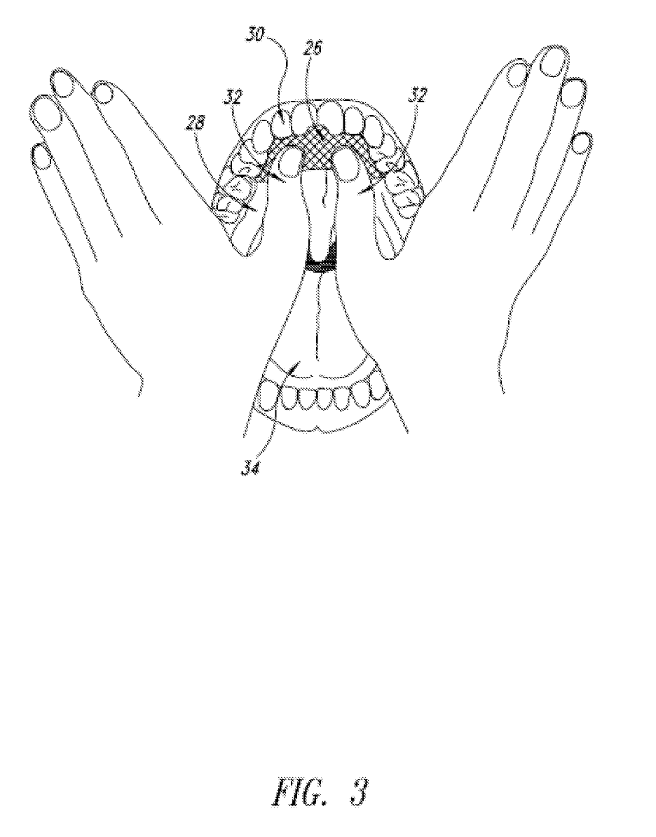

The two-layer foam tray and plastic unit 26 with the foam tray 16 having the plastic layer 20 positioned in alignment thereon is placed in the same hot water until the plastic layer 20 is clear and pliable. Then the two-layer tray and plastic unit 26 is placed in the mouth as shown in FIG. 3 with the plastic facing upwards towards the palate 28. The tray and plastic unit 26 are immediately adapted to the palate 28 and the sides of the upper teeth 30 by the user's thumbs 32 and tongue 34. The tray and plastic unit 26 should be held in place with the tongue 34 for approximately five minutes or until the plastic layer 20 has cooled and returned to a rigid, opaque state.

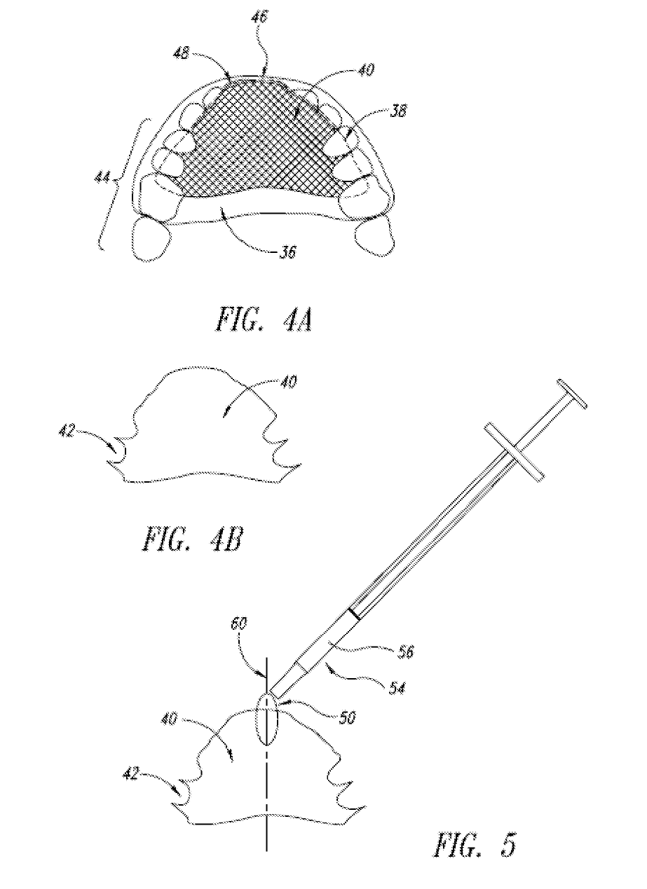

Once cooled, the foam tray and plastic unit 26 are removed from the mouth, and the foam tray 16 is peeled off the rigid plastic material layer 20. Next, the excess plastic 36 is cut off following the diagram of cut lines 38 as shown in FIG. 4A to form a palatal component 40.

As shown in FIG. 4B, the trimmed palatal component 40 has scalloped edges 42 corresponding to the insides of the back teeth 44 and covering all of the palate, but not the biting edges 46 of the front teeth 48, shown in FIG. 4A.

Referring to FIGS. 5-7, the next step of adding a discluding element 58 to the palatal component 40 to form the completed device 52 is illustrated. First, a syringe 54 is filled with beads or small slivers of the same thermoplastic material 56 used to form the palatal component 40. The syringe 54 and thermoplastic material 56 therein are placed into a bath of water that is at a temperature in the range of 145° F. to 180° F. and ideally at 160° F. This turns the thermoplastic material 56 into a clear and pliable state.

After the thermoplastic material 56 has become clear and pliable, the syringe 54 is used to form a mound 50 of the thermoplastic material 56 on the palatal component 40 in the area that would be behind the two front teeth 48 and preferably centered between the two front teeth 48. As shown in FIG. 5, the mound 50 should be centered laterally with respect to a longitudinal axis 60 of the palatal device 40, which should correspond to a location between the two front teeth 48.

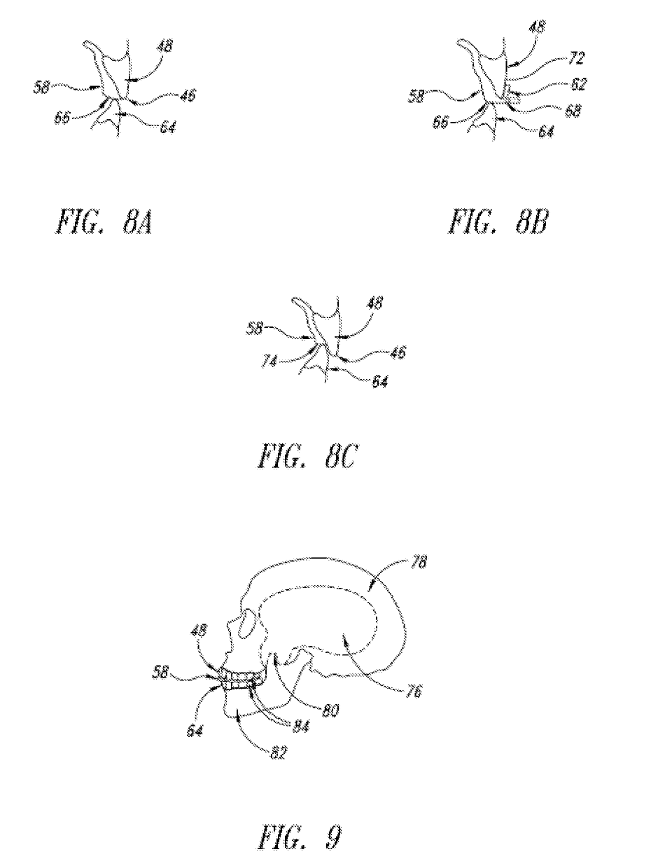

Ideally, the mound 50 of thermoplastic material 56 is allowed to build up to approximately 4 mm to 6 mm high and continuing anterior to the edge of the palatal component 40 or beyond, depending upon the extent of wrap desired onto the front teeth as described more fully below with respect to FIGS. 8A-8C.

While the thermoplastic material in the form of the mound 50 on the palatal component 40 is still soft and pliable, it is placed into the mouth as shown in FIG. 3, and the mound of thermoplastic material 50 is smoothed with the user's tongue. The mound of thermoplastic material 50 should be wrapped around the two front teeth 48 and allowed to cool, where it hardens and turns opaque.

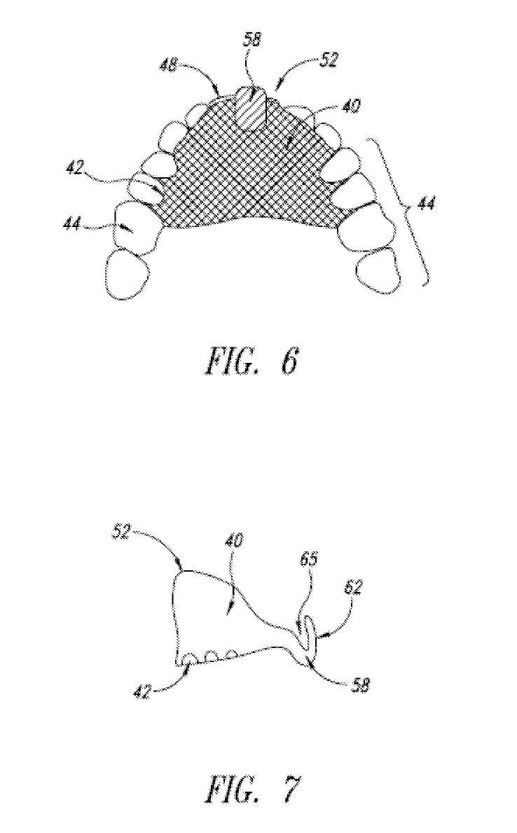

FIG. 6 illustrates the completed appliance 52 as viewed from the tongue when correctly positioned on the roof or palate of the mouth. The discluding element 58 is slightly wider and flatter once smoothed by the tongue. It is also bonded to the underlying palatal component 40. The scalloped edges 42 fit closely to the back teeth 44 and the forward area rests at the back of the front teeth 48.

FIG. 7 is a side view of the completed appliance 52. The discluding element 58 is shown having an upward projecting section 62 that creates a valley 65 in which the front teeth are positioned. When correctly placed in the mouth, the upwardly extending portion 62 extends across the front surface of the front teeth 48. Alternately, the plastic remains extended over occlusal surfaces of the back teeth 44 for a smoother lingual transition and additional retention.

FIGS. 8A-8C illustrate three different configurations of the discluding element 58 in reference to the biting edge 46 of the front teeth 48. In FIG. 8A, the discluding element 58 has a terminating end 66 that stops at the biting edge 46 of the front teeth 48. This is a more cosmetic design that can still give moderate separation of the back teeth and it provides a biting surface 66 for the bottom front teeth 64. In FIG. 8B, the discluding element 58 has an extension 68 that extends out of the mouth beyond the biting edge 46 of the front teeth 48 and preferably has the upward extending portion 62 that wraps around and onto the front surface 72 of the front teeth 48. How far forward this platform 68 extends will be determined by how far forward a user's jaw extends when grinding.

Finally, in the embodiment shown in FIG. 8C, the discluding element 58 has a terminating end 74 limited to just the area immediately behind the front teeth 48, substantially shorter than the terminating end 66 illustrated in FIG. 8A. This design is very cosmetic and recommended for daytime use only or for users that clench but do not grind their teeth.

Illustrated in the side view of FIG. 9 is the temporalis muscle 76 extending from the skull 78 to its attachment 80 on the lower jaw 82. Contraction of the temporalis muscle 76 helps the jaw 82 to close. When a mound of material, such as the discluding element 58 described above, is placed between the biting surfaces of the upper front teeth 48 and lower front teeth 64, only the lower front teeth 64 will contact the discluding element 58 in the embodiments shown in FIGS. 8A and 8C, preventing the upper and lower back teeth 84 from coming into contact with each other and thus minimizing contraction of the temporalis muscle 76 in addition to preventing clenching and grinding.

Alternative embodiments of the present disclosure are now described below.

In a first alternative embodiment, during fabrication of the palatal component 40, the foam tray 16 can be omitted. Thus, the pliable thermoplastic material is formed to the palate using the fingers and tongue without the tray.

In another embodiment, an adhesive is applied to the tray in order to help retain the sheet to the tray while it is submerged into the water bath and placed in the mouth.

Alternatively, a thermoplastic material having a softer tissue side and a harder outer side could also be used. While the thermoplastic material ideally is in a sheet or wafer form, it can be in another form that is commonly available, such as beads or buttons that can be melted and formed into an appropriate wafer or sheet.

In another embodiment, a polyvinyl dental impression material or other appropriate chemical set materials can be used instead of a thermoplastic material.

As an alternative to using a syringe to apply the discluding element, a small piece of thermoplastic material could be heated and applied with ones fingers. The receiving portion of the palatal retainer should be simultaneously heated to ensure good bonding.

Inasmuch as the completed appliance is customized for each user, the extent of palatal coverage may be altered to have more or less coverage. The design of the discluding element 58 may extend up the facial surface of the incisors in the mouth for added retention, similar to the configuration shown in FIG. 8B for the front teeth. Thus, the discluding element may extend several millimeters beyond the incisal edge 46 to protect the teeth in users having an active protrusive action.

Alternatively, the design of the discluding element 58 may be limited to the lingual surface of the central incisors in the area of occlusion to make the appliance less bulky and easier to close one's lips and to speak, as shown in the embodiments of FIGS. 8A and 8C. The design of the discluding element 58 may deviate from the standard horizontal in reference to the maxillary teeth to one where the angle matches the condylar angle.

It will be appreciated that the foregoing disclosure is directed to two basic components. First, the discluding element 58 serves to provide a platform for the lower teeth to contact when closing in order to prevent complete closure of the mouth. The size of the discluding element or platform has two criteria. First, it is usually limited in size not to extend laterally beyond the distal (lateral) sides of the central incisors, which prevents the canines from touching it in lateral movement. However, it may extend to cover all of the upper anterior teeth. Second, it is thick enough to keep the back teeth and canine teeth from touching the opposing teeth when the mouth is closed. However, it may overlap the front surface of the incisors to give secondary retention.

The second component is the palatal portion, which is the foundation for the discluding element and also serves as the primary source of retention to hold the appliance in the mouth without the need for wires or other retentive components.

The ability of the user to directly fabricate their own custom appliance to help relieve and prevent their headaches offers a very positive option to taking medication. As will be readily appreciated, the appliance can also be used as a diagnostic screening tool. If the user does obtain relief by wearing such a device, other more organic diagnoses may be ruled out. The present disclosure also offers dentists a treatment option that is made directly in one appointment and requires no lab bill. It also enables the dentist to customize the angle of the discluding element to more closely match the angle of the TMJ during protrusion, thus providing a more comfortable fit for the patient.

In accordance with another embodiment of the present disclosure, a method of intraoral fabrication of a palatal appliance is provided that enables addition of functional components to the appliance.

### Plastic Blank:

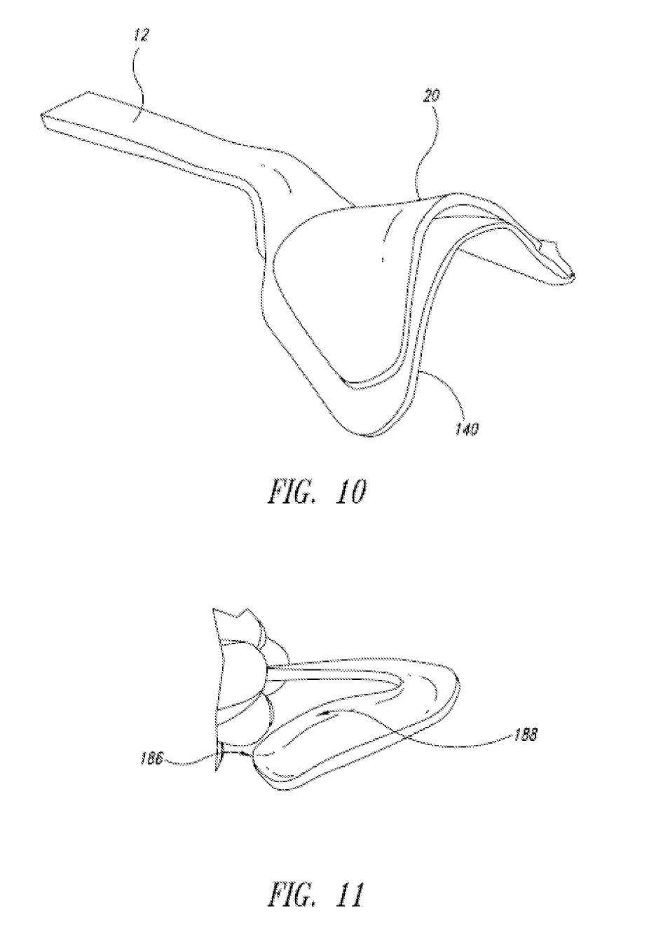

In this embodiment, shown in FIG. 10, a 1-1.5 mm sheet of thermoplastic material 20 is arched to adapt to an anatomically generic dental model. It is made large enough to cover an average sized palate and extend to cover at least the inside gingival margins of all the upper teeth. When heated and applied to an individual's palate, it adapts to the palate and the inside surfaces of the upper teeth. This provides the primary retention for the appliance and acts as a support platform for the functional components. Although other materials may be used, the thermoplastic material used in this embodiment is polycaprolactone (PCL). It is a polymer approved by the FDA for use in the human body. Opaque and rigid at room temperature, it turns clear and molten when heated.

### Tray:

The purpose of the tray 140 is to serve as a carrier for the plastic blank 20, which becomes droopy and sticky once heated to its molten state. Due to its flexibility, the tray 140 allows for adaptation of the molten plastic with the tongue and fingers. The tray 20 also prevents the fingers from sticking to the molten material.

To create a tray 20, a sheet of polymeric foam material 2 mm to 4 mm thick is vacuum formed or pre-formed using known methods over a stone model to create an anatomical contour that fits over the upper teeth and palate. It is to be understood that other known methods of forming trays can be used as well.

Depending on the intended use of the tray 140, the periphery may be cut to just beyond the outside borders of the plastic blank 20 to minimize the size of the tray or it may overlap the occlusal ridge and facial surfaces, to provide more lateral resistance or extended coverage. An extension 12 in front of the central incisors may remain untrimmed to serve as a handle.

### Method of Use:

Once the desired plastic blank 20 and any additional components are positioned in the preformed tray 140, the whole unit is immersed in hot water 140-160° F., or placed in a warm oven until the thermoplastic material becomes clear and molten. The unit is then removed from the heat source, placed in the user's mouth and adapted to the palate. Once the plastic has cooled and hardened, in approximately 4 minutes, the unit is removed from the mouth and trimmed. The finished appliance may be reheated in segments and readapted if a better fit is required.

In accordance with another aspect of the foregoing embodiment, a one-step full coverage night guard or orthodontic retainer is provided. A horseshoe shaped occlusal platform is placed in the tray along with the plastic blank to fabricate a full coverage night guard/orthodontic retainer.

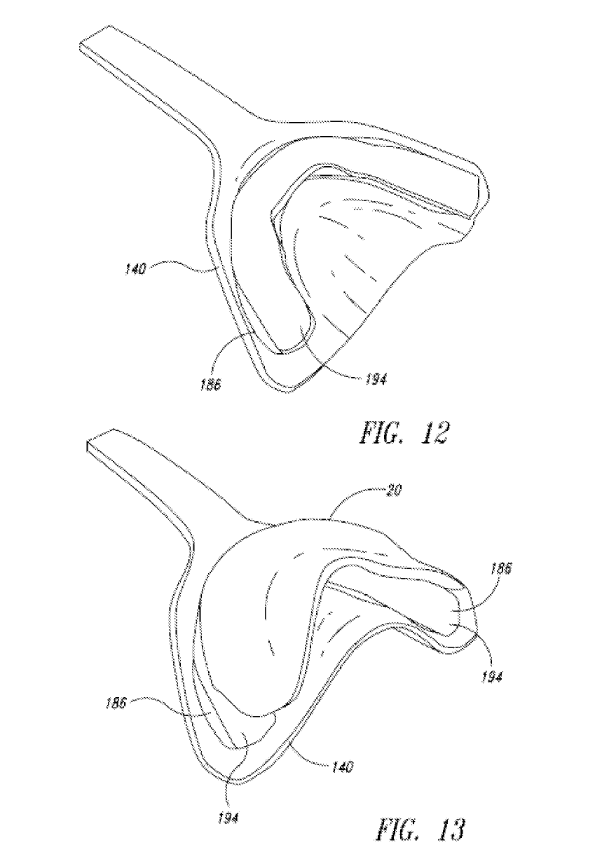

FIG. 11 shows an occlusal platform 186 with sides 188 turned towards the palate for a smoother finish line. FIG. 12 shows the occlusal platform 186 laminated with thermoplastic material 194 in the tray 140, and FIG. 13 shows the tray 140 with both palatal blank 20 and occlusal platform 186 in place.

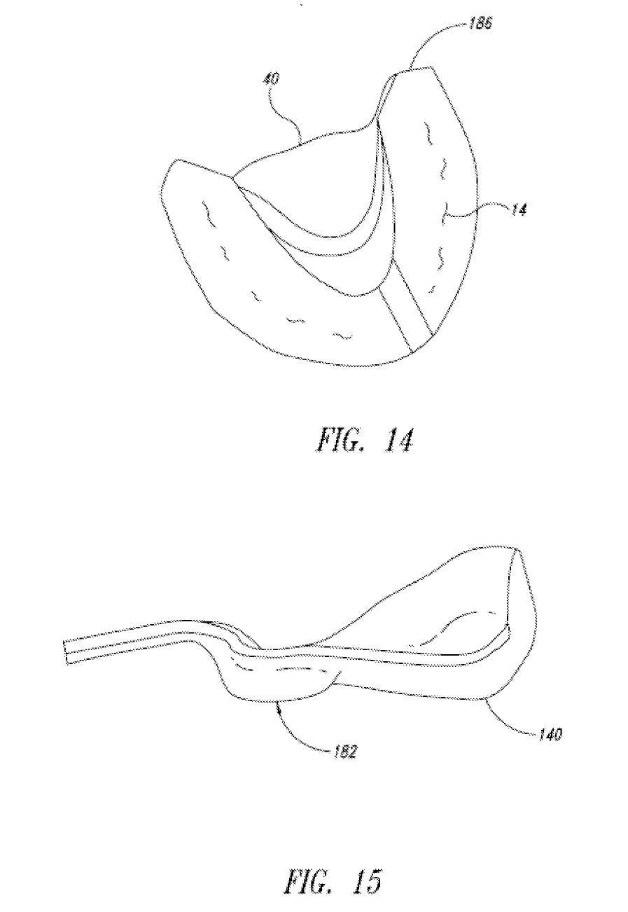

To form the device, the tray-and-plastic unit are heated and immediately adapted to the user's palate with the tongue and thumbs. By biting down firmly (see bite marks 14), the occlusal platform 186 is molded to the individual's occlusal scheme. The appliance is held in place with teeth together and tongue on the palate until the plastic is cool and hard. The completed appliance is shown in FIG. 14.

FIGS. 15-20A and 20B illustrate yet a further embodiment of the present disclosure directed to a one-step anterior deprogrammer. An anterior deprogrammer 100 is placed in the tray 140 along with the plastic blank, and the entire unit is heated and placed in the mouth in one step, then trimmed.

In FIG. 15, the tray 140 is vacuum formed over the model with the plastic blank and the deprogrammer in place. The tray 140 provides a depression 182 in the anterior to accommodate the anterior deprogrammer

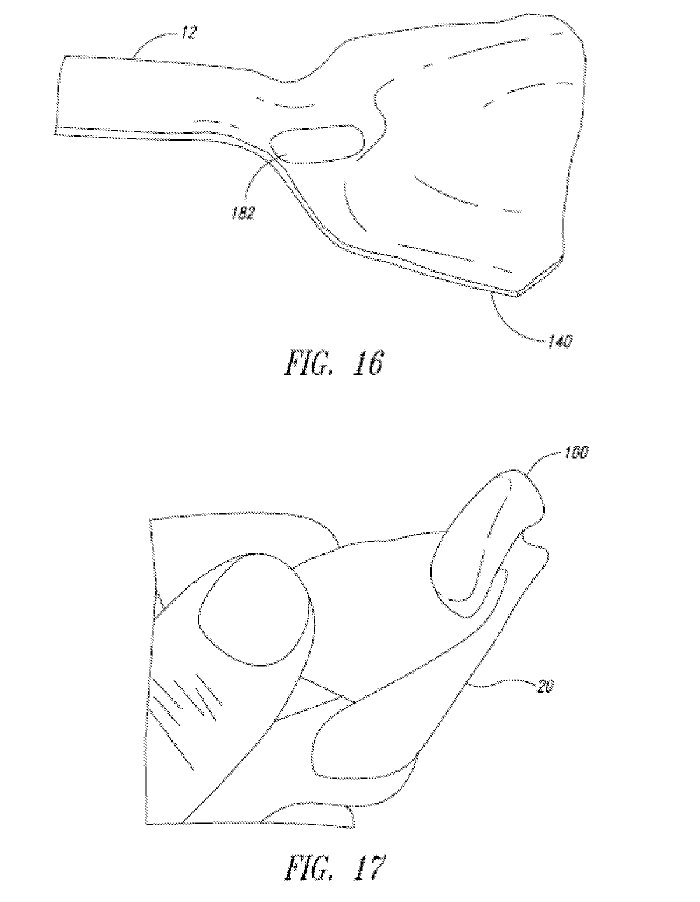

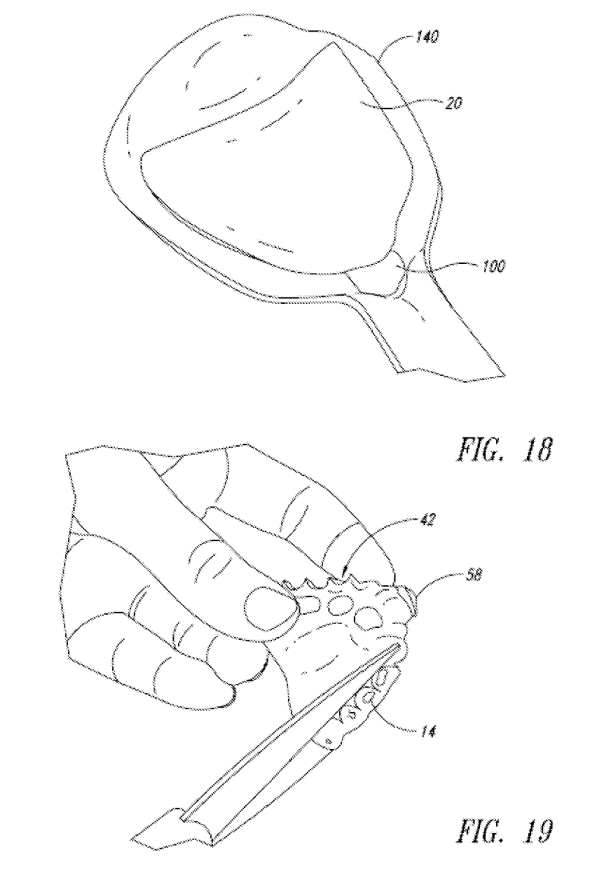

FIG. 16 is an inside view of the tray 140 with a seat 182 for the deprogrammer and reservoir for the overflow of plastic. In FIG. 17, the plastic blank 20 is pre-sealed to the deprogrammer 100. The blank 20 and deprogrammer 100 are then placed in the tray 140 ready to be heated as shown in FIG. 18.

The tray-and-plastic unit is heated, then immediately placed on the palate with the trough of the deprogrammer centered on the two front teeth. The palate portion is adapted with the user's tongue and/or fingers. A light bite on the back of the deprogrammer is used to promote proper adaptation and palatal angulations of the appliance. The appliance is held in place until all plastic has cooled and hardened.

Once cooled, the unit is removed from the mouth and trimmed through the bite imprints up to the discluding element as illustrated by the scalloped edges 42 shown in FIG. 19. FIG. 20A shows the completed appliance. FIG. 20B shows a palatal component 40 with bite marks 14 in a vinyl shell 108 (described more fully below) along a bottom surface of the discluder element 106.

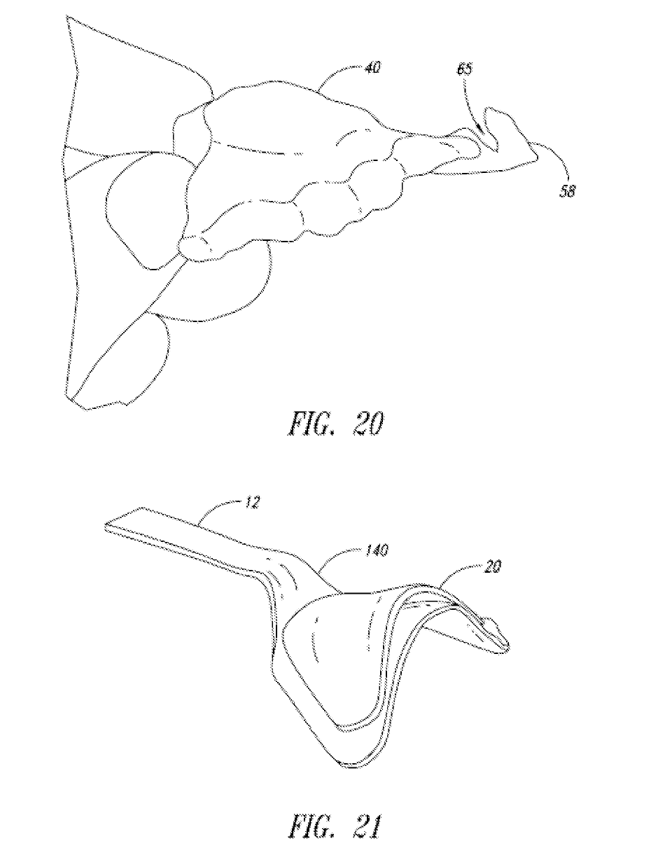

Referring next to FIGS. 21-24, shown therein is a two-step anterior deprogrammer. In this embodiment, The palatal retainer is formed and trimmed, then an anterior deprogrammer of varying designs or a bite stop can be is added to the upper incisors.

More particularly, FIG. 21 shows the tray 140 with plastic blank 20 in place. The tray-and-plastic unit is then immediately placed on the palate. The palate portion is adapted with the user's tongue and/or fingers. The appliance is held in place until all plastic has cooled and turned opaque again.

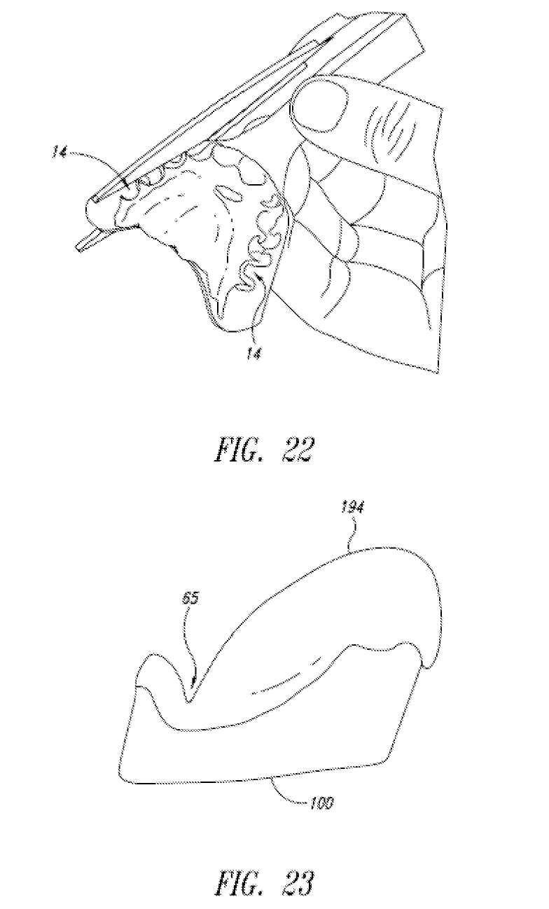

Once cooled and removed from the mouth, the excess is trimmed through the middle of the biting imprints 14 up to the incisors as shown in FIG. 22.

An acrylic deprogramming unit 100 shown in FIG. 23 is laminated with thermoplastic material 194.

Once the palatal retainer has been molded, cooled, trimmed and placed back onto the palate. The deprogramming unit is heated until the thermoplastic material is molten. It is then immediately inserted with the central incisors centered in the trough of the deprogrammer. A light bite on the back end of the deprogrammer is used to promote proper adaptation and palatal angulations of the appliance. The appliance is held in place with the tongue until all plastic has cooled and hardened.

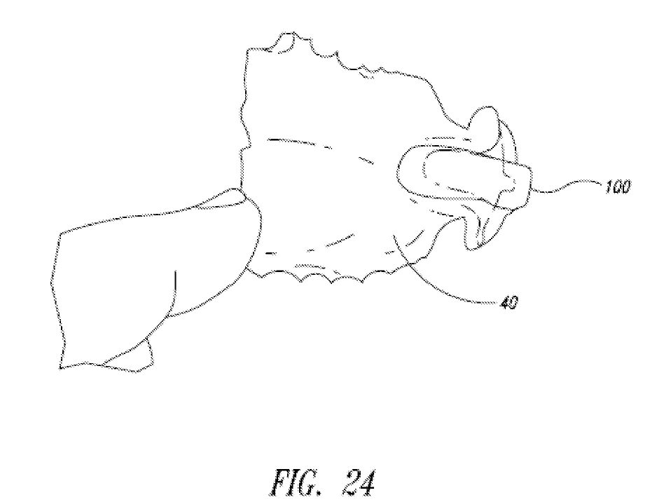

FIG. 24 shows the finished appliance using an NTI brand as the preformed deprogrammer 100, and the palatal retainer 40.

Note: In this embodiment, an acrylic deprogramming unit was utilized. There are multiple designs and materials that would work. One embodiment incorporates a more resilient material to accommodate uneven biting edges on the lower teeth.

FIGS. 4A-4B and 5 illustrate where to trim the palatal retainer and the adding of a deprogramming element from a syringe of molten plastic. The molten plastic is then shaped intraorally by the tongue into the shape of the deprogramming element. In another embodiment, a small bead or bullet of molten plastic could be applied manually to the backs of the front teeth, and molded into shape with the tongue.

### Surgical Healing Stent:

Often times, surgery on the palate leaves an open wound that needs to be covered to facilitate healing and minimize pain. The direct fabrication of a stent prior to the surgery vs. indirectly on a study model saves time and money. Also, with the option of reheating and readapting the stent, modifications to accommodate swelling or dressings can be made easily at the end of the surgery.

The fabrication would be similar to the first step of the two-step anterior deprogrammer.

### Palatal Obturator:

A palatal obturator is a prosthetic appliance that covers an opening in the palate that leads to the nasal cavity. It is basically a plastic, removable retainer which aids in speech, eating and proper airflow. In some cases, the appliance needs to be altered in shape as healing or surgery occurs. Examples of patients needing palatal obturators are people with cleft palates, those who have had tumors removed and those that have had traumatic injuries to their palate.

This method of direct intraoral fabrication of a palatal obturator offers many immediate and cost effective applications. The fabrication would be similar to the first step of the two-step anterior deprogrammer.

In accordance with another embodiment of the present disclosure, further improvements and aspects of an intraoral device are described below.

### Materials

LINING MATERIALS: Although several lining materials can stand on their own as the solo material used to form the palatal retainer or the DE, many applications have a vinyl outer surface (shell) lined with one of the following materials on the palate side. The lining material should be low viscosity so that it duplicates the surface texture of the palate and teeth. It should be rigid enough to maintain its shape to provide adequate retention, but flexible enough to be removed as needed.

THERMOPLASTIC MATERIAL: A material approved for intraoral use, which becomes molten at 140-170° F. and is firm at body temperature is Polycaprolactone (PCL), approved by the FDA for intraoral and internal medical uses. It is readily available from medical and dental supply distributors.

PCL is usually purchased in the form of small beads. Once heated, the beads are coalesced into a ball and then hand worked into a sheet approximately 1-1.5 mm thick. By placing the material to the edge of the vinyl shell, once heated and adapted to the user's mouth, the material flows slightly beyond the cut edge of the vinyl resulting in a comfortable, smooth edge to the finished appliance. If trimming is necessary, the appliance can be reheated and readapted for a smooth finish.

Chemical set polymers and light-cured (such as UV light cured) materials that are approved for intraoral applications may also be used. However, their use is sometimes difficult in a user made appliance. Whenever a rigid or semi-rigid setting material is placed in ones mouth, there is a chance of the material extruding into an undercut area and “locking on”. Gross undercuts should be blocked out, but the risk of routine locking on is minimal. With the thickness of the lining material being 1.5 mm or less, there is minimal excess material to lock on. Also, with the resulting palatal retainer being thin, it has enough flex to release almost any locked-on area. Holding hot water in ones mouth would soften the thermoplastic material and assist release.

TRAY MATERIALS: Most embodiments use a flexible pre-molded tray onto which the other components are positioned. The tray is useful because low viscosity materials are difficult to control. They are sticky and tend to droop, making it difficult to adapt to the palate. The tray is strong enough to maintain its shape under the weight of the materials, but adequately flexible to be adapted to any shaped palate. The use of a standard size tray is practical and possible due to the fact that the average width and height of most human adult palates has a variation of approximately +/−5 mm, which is well within range of the materials used.

Foam sheets 2-6 mm thick are adequate. They are readily available in craft stores.

Vinyl sheets approximately 1 mm to 2 mm thick also work well and are available from dental supply distributors. The 1 mm thickness of ethylene vinyl acetate (EVA) is commonly used by dentist and dental labs to construct soft night guards. The vinyl can have a dual function. It can function as the tray and remain as a vinyl outer coating (shell) on the finished appliance. It is thermoplastic, but it softens at higher temperatures than PCL. Even when heated in hot water 140-170° F. the vinyl holds its preformed shape and supports the lining materials. If chemical (adhesive) or mechanical retention is applied to its lining surface, the vinyl will remain attached to the set lining material. This adds a smooth surface to the tongue side of the appliance. The vinyl is approved for the fabrication of full coverage occlusal guards. Because the biting force on the front teeth is greatly reduced relative to the forces generated on the back teeth, the DE is expected to have a longer lifespan than full coverage guards made of this material.

The extensions of the trays can vary with function, e.g., (1) with or without handles, (2) full coverage of the palate and teeth, and (3) horseshoe shaped with the palatal portion removed.

ADHESIVE: Tray adhesive for polyvinyl impressions is available through dental supply distributors. Other adhesives known to manufactures may also be used.

COMPONENTS FOR BITING SURFACES: There are a number of materials adequate to be used as the DE and occlusal guard materials. Thermoforming materials such as high-impact polymers and coping materials are readily available from dental supply companies. Also injection molded acrylics could be used.

### More on Discluding Elements and Palatal Retainers:

The present disclosure is not limited to defining the parameters of any of the functional components. Rather, the description herein demonstrates the ability to incorporate most designs of functional components into an appliance that is made directly on the user.

In accordance with still yet a further aspect of the present disclosure, a device is provided that includes: (1) A discluding element (DE) positioned on the upper front teeth which functions as a platform for the lower teeth to contact when closing; preventing complete closure of the back teeth, and (2) A palatal retainer, which functions as the foundation and support for the discluding element and also serves as the primary source of retention for the device.

### Discluding Elements

The design of the discluding element can vary greatly. The one consistent variable is that the DE is thick enough in the area where the lower teeth contact the DE that it prevents the upper and lower back teeth from coming in contact. FIG. 8A shows the thickness variations. The biting plane is usually parallel or near parallel to the biting surfaces of the upper posterior teeth, however in occlusal schemes with deep anterior overbites, the biting plane may be angled from the incisal edge towards the palate, or stepped down to reduce the thickness of the DE behind the upper incisors. This reduced thickness would help minimize the amount of vertical opening. The width of most discluding elements is at least wide enough to contact at least one lower incisor tooth, and is often limited to about 6 mm-10 mm so that the canines cannot contact each other or the appliance in any functional movements. However, some designs span the width of all anterior teeth, canine to canine, as in a bite plane device, and in U.S. Pat. No. 7,234,467. The length in an anterior/posterior direction is in a range from about 8 mm to about 18 mm. There may be a protrusion projecting anteriorly from the biting edge in the range of 3 mm. The variation in size depends on the intended use and the degree of grinding expected.

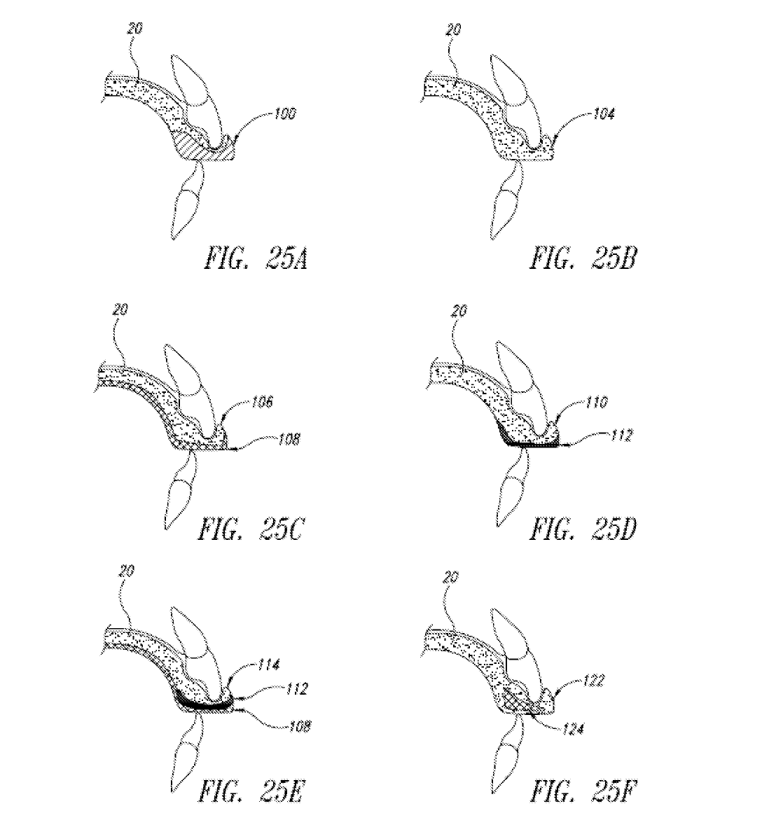

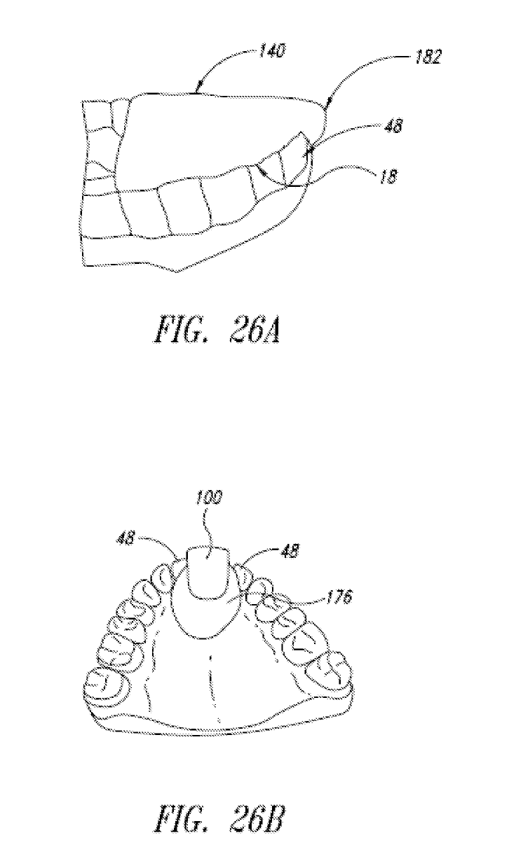

### Discluding Element Embodiments FIGS. 25A-F

ONE-STEP PROCESS—In this version, the DE is attached (or being formed) while the palatal portion is formed. The thickness of the preformed structure will determine the amount of lining material used.

1. Full thickness of the DE 100 is illustrated in FIG. 25A.

2. Hard shell on the surface of the DE 100 is shown in FIGS. 25D-E.

3. Hard substructure embedded in the DE lining material is shown in FIG. 25F.

When there is no preformed component, the DE shape is determined solely by the shell or tray so that the DE is 100% lining material, illustrated in FIG. 25B. By modifying the thickness and extensions of the DE models, all DE designs in FIGS. 8A-8B can be achieved

TWO-STEP PROCESS—In this version, the DE is attached after the palatal portion is formed. If preformed, then the DE will be the full thickness. If custom, there is no preformed component. A more detailed explanation of the above outline follows below:

In FIG. 25A, the DE 100 is preformed in a rigid material and attached to the palatal blank 20 while the retainer is being formed. This DE 100 is sized to approximate the finished product. This design requires only a thin layer of lining material to attach it to the palatal retainer. While it offers the most rigidity, it allows the least amount of customization.

FIG. 25B illustrates a DE 104 formed entirely out of the same or compatible material as the lining material.

In FIG. 25C, a DE 106 is formed as in FIG. 25B, but it has an outer vinyl shell 108 that may or may not extend to cover the palate. It is to be noted that using 100% lining material for the DE offers the most customization opportunities.

FIG. 25D shows a DE 110 is formed as the DE 104 is formed in FIG. 25B, but it has an outer hard thin shell 112 (no vinyl shell).

FIG. 25E shows a DE 114 formed as the DE 104 is formed in FIG. 25B, and it includes a thin outer hard shell 112 with an outer vinyl shell 108. Using a thin outer hard shell made of acrylic or vacuum formed from sheets of high impact polymers offers moderate rigidity and a more wear resistant surface than the lining material.

In FIG. 25F, a DE 122 is again formed as the DE 104 is formed in FIG. 25B, and it includes a preformed rigid substructure 124 embedded in the DE material 122. To provide customization of the bite, the insert should be small enough to allow at least 1 mm of lining material on the biting side. It should allow for enough material on the palatal side to adapt to all palate shapes without impinging on the palatal tissue, approximately 1.5-6 mm. The substructure could overlap the incisal edges of the teeth involved or end behind (lingual) said teeth. It is basically a scaled down DE that is embedded in the lining material.

In another aspect, two steps can be used to form the device. The preformed 15 acrylic DE is lined with material compatible with a previously formed palatal retainer. Preferably the lining is bonded to the previously formed retainer.

### Palatal Retainer

Palatal retainers have been successfully used for decades as a method of retaining upper arch functional components. They are basically a curved sheet of material which conforms to the roof of the mouth (palate) and the inner surfaces of the upper teeth. Retention is achieved by the material protruding slightly into the indentations between the teeth, the parallelism created by the sides of the teeth, and the close adhesion to the soft tissue of the palate. When the palatal retainer is smooth and thin, it is very well tolerated by most users.

### Bite Stops

Bite stops allow for a customized bite and angle in which the jaw moves down and forward (protrusive angle). It includes bite stops on the posterior molars to regulate the amount of vertical closing. When the user bites on the bite stops, their lower front teeth hit the DE and depress into the molten thermoplastic only to the depth determined by the posterior bite stops. A protrusive rubbing of the lower teeth on the DE will mold the DE to the individual's protrusive angle.

The different configurations of the DE described above could employ the use of bite stops. The bite stops are helpful in ensuring a measured amount of vertical opening; however, if the DE has a rigid component to it, it will not allow customization of the protrusive angle.

Ideally, the bite stops could be made of any suitable material that will not deform when bitten. They should be smooth to the tongue and be large enough to cover most of the upper molars in order for the lower teeth to easily contact them, but small enough as to not gagging or pinching of the cheek. The thickness should be enough to insure that all back teeth will be not come in contact with the opposing teeth when the appliance is in place. A generalized size could be a round 12 mm diameter disk that is 3 mm thick.

Fabrication Method:

1. Create a model of a discluding element that is extended to adapt to the palatal surface;

2. Place the DE model on the upper front teeth of a full upper arch model, as shown in FIGS. 26-B. The DE 126 is centered on the front teeth 48. A cut line 18 is shown in FIG. 26A for extended trays. The cut line is approximately 3 mm above the facial biting edges.

3. Vacuum forming a thin sheet of vinyl over the models to form a shell.

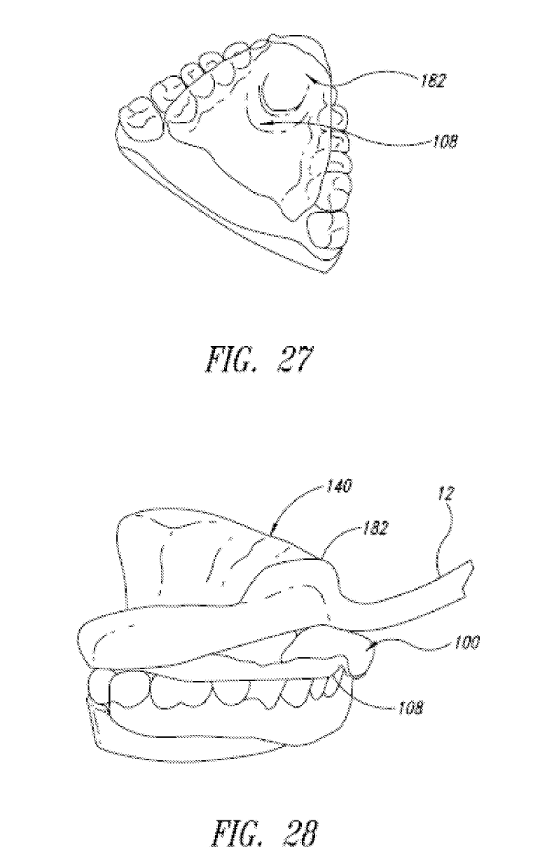

4. Cutting the vinyl shell along the middle of the biting edges of the teeth and leaving a 1-2 mm margin around the DE. FIG. 27 shows a vinyl shell 108 with an imprint of the DE and a reservoir 182.

5. Vacuum forming a foam sheet over the models with the vinyl shell in place to form an outer tray.

6. Cutting the tray along the facial wall of all teeth to approximately 2 mm to 3 mm above all biting surfaces, but leaving an extension in front of the middle incisors for a handle 12. FIG. 28 shows a vinyl shell 108 vacuum formed over the model with the DE 100 in place. The vinyl is trimmed to cover only one-half of the biting surface. A foam tray 140 is formed over the vinyl shell and trimmed beyond the vinyl edges.

7. Coating the palatal side of the vinyl shell with an appropriate adhesive.

8. Placing a 1 mm to 1.5 mm thick lining of thermoplastic material on the palatal side of the vinyl and into the DE area.

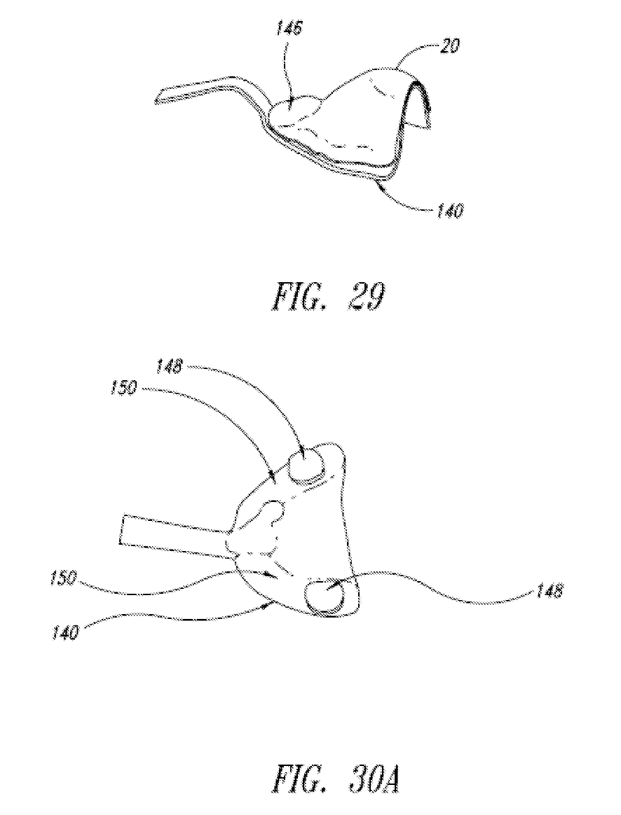

9. Overfilling the DE area with additional thermoplastic material. FIG. 29 shows lining material 20 covering the preformed tray 140. Overfill 146 in the DE area with a wedge of thermoplastic material approximately 2 mm thick and 5 mm high is shaped as a fin or cone to allow faster heating.

10. Bonding 2 mm to 4 mm thick bite stops onto both molar areas on the underside of the tray. This is illustrated in FIGS. 30A and 30B where the bite stops 148 are positioned on the outside 150 of the foam tray 140 (FIG. 30A) and the bites stops 148 shown on the vinyl tray 108 or shell (FIG. 30B).

Customization Method:

The fabrication method described above can be customized using the following steps:

11. Heating the tray/vinyl/plastic unit in water 140-170° F. until the plastic turns molten;

12. Placing the tray/vinyl/plastic unit onto the roof of the mouth while centering the two front teeth into the trough of the DE;

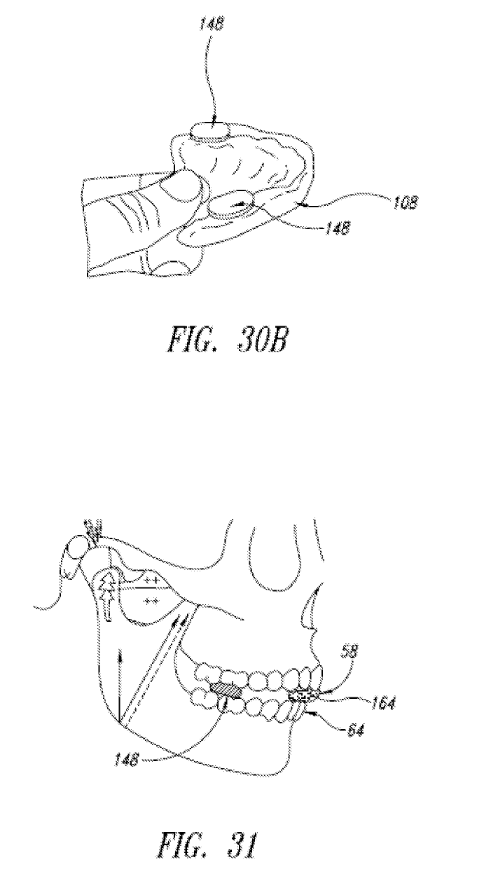

13. User biting onto the bite stops 148 until the lower front teeth 64 contact the DE area 58 and sink into the molten plastic 164 of the DE 58, as shown in FIG. 31.

14. User rubbing their teeth against the DE to shape the protrusive angle.

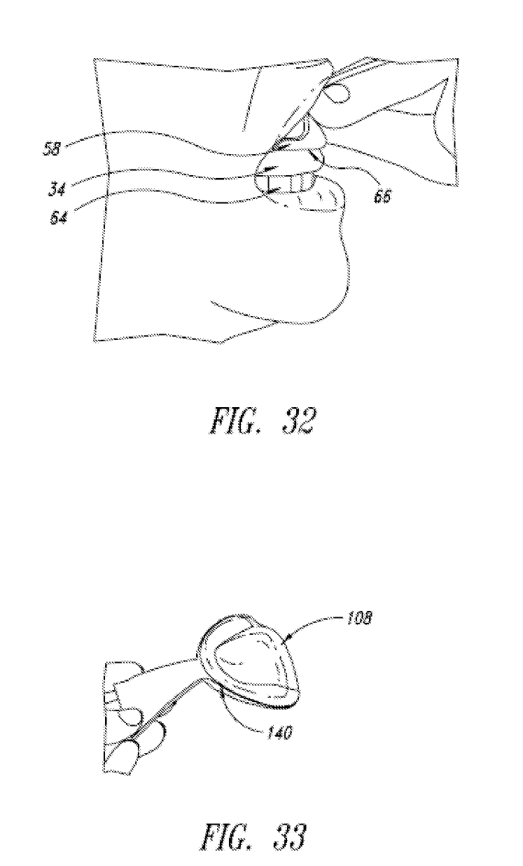

15. User using finger or thumb to push front plane of DE upward to shape the plane more parallel to the biting surfaces of the back teeth. (See FIG. 32.)

16. User holding the unit in place with the tongue until the plastic is cooled.

17. Removing the unit from the mouth.

18. Peeling the foam off the tray.

19. Trimming off excess set plastic from the outside edges of the teeth, between the teeth, and around the DE. (See FIG. 19.)

### Modifications of the Above Embodiment:

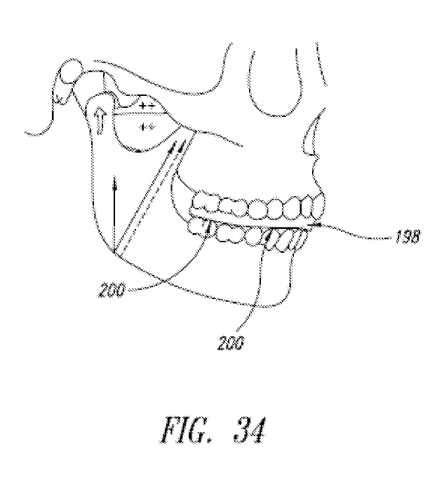

a. The foam tray 140 in FIG. 33 is made into a horseshoe shape by cutting out the palatal part. This leaves the vinyl in direct contact with the tongue for better adaptation while still adding stability to the vinyl. Bite stops are in same position as the full tray.

b. The foam tray is eliminated and the bite stops are placed on the vinyl, as shown in FIG. 30B.

1b. The vinyl functions as the tray or shell. (A handle is optional.) It can be retained to the lining material using known retention methods or it is factory laminated to the lining material where it remains as the outer surface of the final appliance. The user can just peel off the bite stops.

2b. The vinyl functions only as a tray, not as the shell. It has no adhesive or other method of retention to the lining material. Once the material is set, the tray is peeled off and the final appliance exists solely of the material that lined the tray.

c. The foam tray functions only as a tray in that has no adhesive or other method of retention to the lining material. Once the material is set, the tray is peeled off and the final appliance exists solely of the material that lined the foam tray.

### No Bite Stops

All of the previously describe DEs can be used with this embodiment. The appliance is manufactured in a similar manner but the bite stops are eliminated. Once the user inserts the tray containing the unset material, they simply hold their tongue on the roof of their mouth and between their teeth so that they do not bite on the DE. This produces a smooth plane, with no teeth indentations in the finished DE, allowing the user's teeth to slide around on the DE without any interference.

Steps 10, 13, and 14 above are eliminated because the user will not be biting during the fabrication process.

Instructions after Placement in the Mouth are:

(10) The tray or shell with heated plastic is placed into the mouth and adapted to the palate with user's tongue or fingers or both.

(11) The user then holds the unit in place with their tongue adapted to the roof of the mouth and spreads the unit between the upper and lower teeth. The user is instructed NOT to bite on the appliance; however, the user may rest their teeth on their tongue while waiting for the material to set. The edge of the DE is adapted to the front teeth near gum line. FIG. 32 shows the plane 66 of the DE at the lower edge to be parallel to the occlusal surface. The tongue 34 is between the DE 58 and the lower teeth 64 to prevent biting on the DE 58 while holding the appliance against the palate until the lining material is set.

(12) If there is no handle, the user can close their lips around the front teeth and press on the outside of their lip with their finger above the gum line.

(13) Allow approximately 5 minutes to cool then remove from mouth.

(14) Peel off foam tray.

(15) With scissors, trim the excess plastic and vinyl to terminate approximately half-way over the biting surfaces of the back teeth and up and around the DE.

Modifications of trays are same as with the bite stop.

In another embodiment without bite stops, after the heated unit is positioned in the user's mouth, the user bites lightly on the DE just until the front lower incisors indent the tray. The user then refrains from biting deeper into the DE holds the appliance in place with their tongue and follows steps 1-5 above. This method allows for a bite adjustment with minimal indentation into the DE.

### Preformed DE

Another embodiment incorporates a preformed hard acrylic DE, such as is shown in FIG. 20B. It offers better wear properties, but may require bite adjustment.

Fabrication:

1. Placing a model of a preformed discluding element on the upper front teeth of a full upper arch.

2. Molding a block-out material 176 to the underside of the DE 100 in a tapered fashion to blend the underside of the DE to the surface of the palate. This will provide a smooth transition between the DE 100 and the palate and create a reservoir for excess lining material to flow into, as shown in FIG. 26B.

3. Vacuum forming a sheet of tray material over the models to form a pre-arched tray and an imprint for the acrylic DE and reservoir. FIGS. 15 and 16 show the imprint 182 formed in the tray 140 once it is vacuum formed over the model.

4. Cutting the tray along outside edges of the biting surfaces of the teeth and around the DE leaving a 1 mm to 2 mm margin, as shown in FIG. 26A.

5. Placing the acrylic DE 100 in the corresponding imprint 182 in the tray. (See FIGS. 16 and 18.)

6. Placing a 1 mm to 1.5 mm thick layer 20 of thermoplastic material on the palatal surface of the tray and the DE. (See FIG. 18.)

7. Adding approximately 2 mm to 4 mm of additional lining material 146 onto the DE to ensure adequate plastic to adapt to any palate shape. See FIG. 29.

Customization:

8. Heating the tray or DE unit until the plastic turns molten.

9. Adapting the tray or DE unit onto the roof of the mouth while centering the two front teeth into the trough of the DE.

10. Allowing the plastic to cool in the mouth.

11. Removing the unit from the mouth and peeling the tray off the cooled lining material.

12. Trimming off excess plastic from the outside edges of the teeth and around the DE. (See FIG. 19.)

13. Adjusting the bite on the DE.

Occlusal Guards with Preformed Occlusal Platform

This embodiment relates to providing an occlusal biting surface on the front and back teeth. The use of a palatal retained occlusal guard improves retention and allows minimal facial coverage. Using a thin layer of a semi-rigid of lining material, the appliance is retentive and does not have the spring of guards that use a more resilient material. With added retention of the palatal retainer, coverage of the facial surfaces of the teeth can be minimal or eliminated.

(1) Place the selected occlusal platform onto a generic model, or vacuum form a 3 mm sheet of high-impact polymer used for night guards (available at dental supply companies) and cut into a horseshoe shape to cover the occlusal surfaces of the teeth. FIG. 11 shows the occlusal platform 186 in which the lingual side 188 is contoured up towards the palate to make a smooth transition.

(2) Vacuum form a foam sheet over the occlusal platform, trim about 3 mm up the facial surfaces to form the trimmed tray 140 as shown in FIG. 12, where the occlusal platform 186 is laminated with thermoplastic material 194.

(3) Line the inside of the foam tray and occlusal platform with 1 mm to 1.5 mm thermoplastic material 20, which is shown more clearly in FIG. 13.

Method of Customization

(5) Heat the unit in hot water, preferably at a temperature in the range of 140 degrees F. to 170 degrees F.

(6) Center the heated unit over the teeth, bite down and hold teeth together, create a sucking vacuum to adapt the palate area. Open the mouth and use the fingers or thumb to adapt the pliable unit to the palate.

(7) Press on the outsides of the teeth to adapt material to the sides of the teeth.

(8) Let the material cool and return to rigid state. Then remove the unit from the mouth and peel off the tray.

(9) Trim the outside edge to the desired level. Note: The less material on the outside surfaces of the teeth, the less retention.

(10) Reheat and readapt the unit as necessary.

FIG. 14 shows the finished full coverage occlusal guard with the bite marks 14 distributed throughout the occlusal platform 186. Primary retention is the palatal retainer 40.

### Full Contact Permissive Guard

This embodiment provides a full contact permissive splint. They are designed with a shallow canine-to-canine ramp, which provides horizontal freedom of movement as well as immediate disengagement of all posterior teeth. This design provides a large surface area of shared biting force resulting in reduced TMJ loading forces.

In this embodiment, the posterior biting surface height is determined by an anterior bite stop (the DE). The intensity of the bite on the back segment is limited by the anterior bite stop. This limitation provides for initial cusp contact without producing any indentations that would interfere with smoothness of the biting surface. FIG. 34 shows the full contact permissive guard 198 and the cusp tips 200 contacting only the biting surface of the splint, not indented into the surface. The retentive feature of the palate allows for the facial edges of the back segments to be removed if necessary to reduce the possibility of interferences in lateral movement and/or to reduce bulk.

In this embodiment, a rigid shell is used as the DE. The thickness of the rigid DE will determine how much additional lining material will be needed in the DE area.

1. Create a model of an anterior discluding element 204 that covers all six anterior teeth, canine to canine, as shown in FIG. 35, and it is thick enough to be parallel with the upper occlusal table.

2. Vacuum form a rigid shell of the DE from 0.5 mm temporary splint 5 material.

3. Place the shell back on the model and build up 206 the posterior biting surfaces to be level and parallel and smoothly blended with the biting surface of the DE. FIG. 36 shows a model with a hard DE shell 202 and the buildup of the posterior biting surfaces 206 in a level plane. The inside surfaces of buildup are blended to the palate.

4. Vacuum form a sheet of 1 mm EVA onto the model.

5. Trim the vinyl shell to the outside edges of the occlusal surfaces and around the DE.

6. Paint the shell with appropriate adhesive.

7. Place the rigid DE shell into the vinyl shell DE imprint (depression).

8. Line the vinyl shell and DE area with 1 mm to 1.5 mm of thermoplastic material.

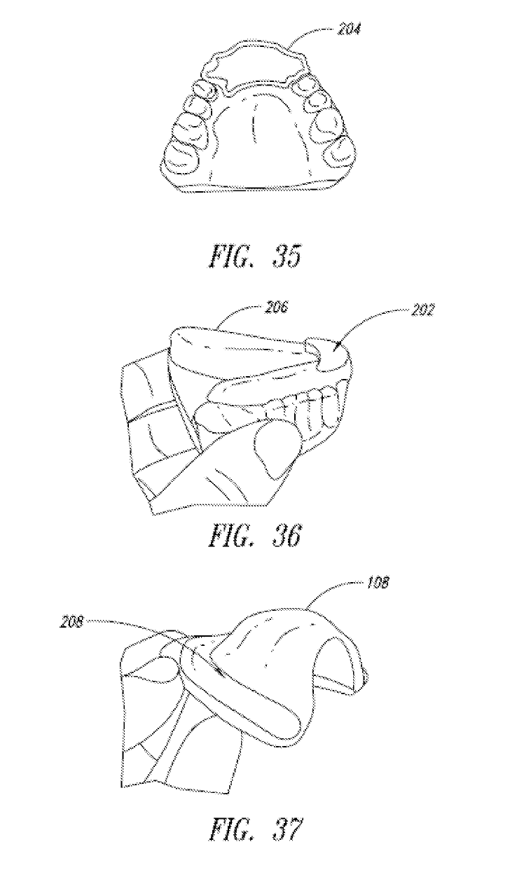

9. Place approximately a 3 mm round log 208 of thermoplastic material into the occlusal imprint and DE imprint of the vinyl shell 108, as shown in FIG. 37.

Method of Customization:

10. Heat the shell and lining until the lining material becomes molten.

11. Place the unit in the mouth with front teeth centered and just behind the edge of the DE shell.

12. With the user's tongue and or thumbs, adapt the unit to the roof of the mouth without undue pressure on the biting surfaces.

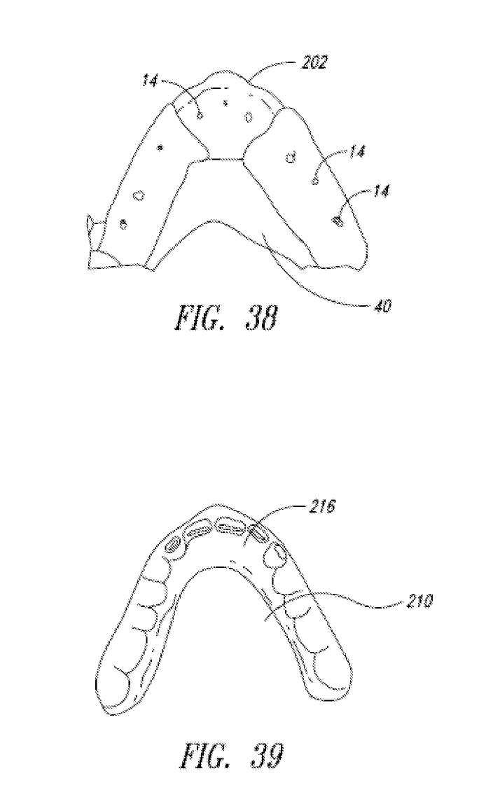

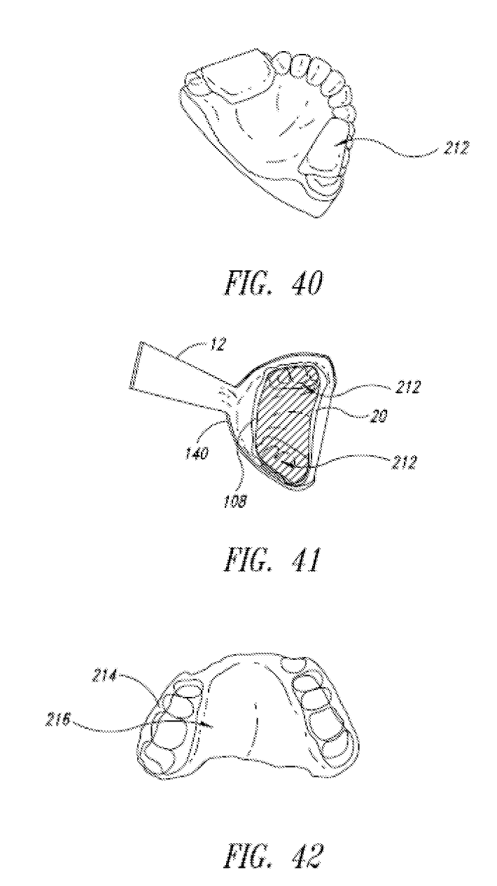

13. User bites down until the front lower teeth touch the rigid DE and the back lower teeth contact the vinyl of the back segment of the vinyl shell. (See FIG. 38 where the bite marks 14 along the front and back segments are circled.)

14. User holds the position with the teeth together and creates suction in the mouth to further adapt the plastic to the palate.

15. After holding the bite for about one minute, the user rubs their teeth side-to-side on the cooling appliance and then continues to hold until the material is set.

16. Remove the appliance and cut off the facial edge of the biting surfaces up to the canines. FIG. 39 shows the internal view 216 of the full splint with palate coverage 210 reduced, and FIG. 38 shows the full permissive splint with even, light occlusal contacts 14 on the vinyl shell 108, and retained by the palatal retainer 40.

17. Reheat areas that require better adaptation or smoothing.

### Partial Coverage Occlusal Guards

1. Prepare occlusal platforms by vacuum forming a sheet of 3 mm high-impact polymer sheet and trimming to cover 2-4 of the back teeth.

2. Position platforms on each side of the model and vacuum form over the model or platforms with a sheet of 1 mm vinyl. FIG. 45 shows the bite platforms 206 positioned on a generic model.

3. Trim the vinyl to terminate 3 mm to 5 mm anterior and posterior to the bite platforms as shown in FIG. 41. The bite platforms 212 are shown in the vinyl shell 108 and foam tray 140.

4. Place the vinyl unit back on the model and vacuum form a foam sheet to form a foam tray.

5. Trim the tray to the outside edges of the teeth, leaving the handle.

6. Coat the vinyl with adhesive.

7. Apply a 1 mm to 1.5 mm layer of thermoplastic lining material over the coated vinyl and occlusal platforms (20 on FIG. 41).

Method of Customization

8. Heat entire tray unit in hot water 140-170° F. until the lining material is clear and molten.

9. Position the unit in the mouth with the handle centered between the front teeth.

10. Bite down on the bite platforms.

11. Use the tongue and fingers to adapt the palatal area.

12. Close the mouth and create a sucking motion or suction to further adapt the palate area. With the mouth remaining closed, biting on the occlusal platforms until the material has cooled and hardened.

13. Remove the unit from the mouth and peel off the foam tray.

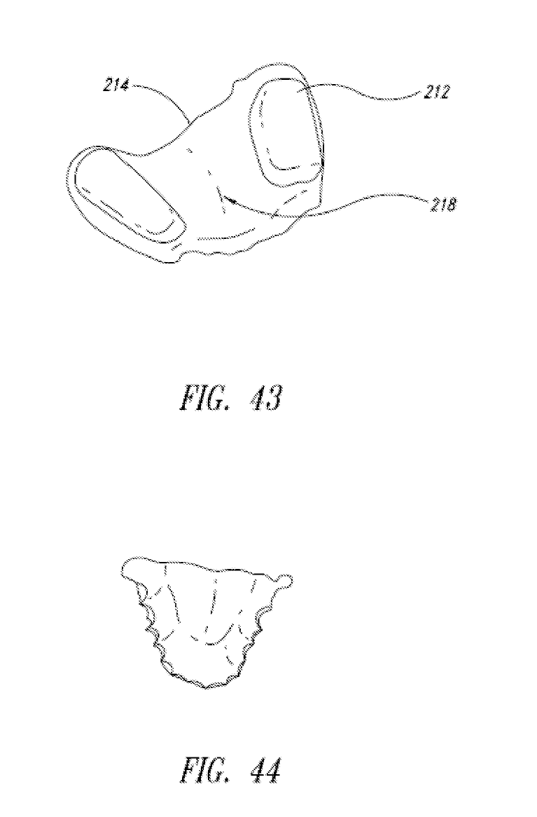

14. Trim and smooth if necessary. FIGS. 42 and 43 illustrate the finished appliance 214, including the internal surfaces 216, and the tongue side 218, respectively.

### Surgical Healing Stent

Often times, surgery on the palate leaves an open wound that is extremely painful for a very long time. Many patients lose a significant amount of weight due to the pain when eating or drinking. Covering the wound facilitates healing and minimizes the pain. The direct fabrication of a stent prior to the surgery vs. indirectly on a study model saves time and money. Also, with the option of reheating and readapting the stent, modifications can be made along the healing continuum to accommodate swelling, tissue shrinkage, and changes in dentistry. All biting contacts on the stent are removed to allow for eating with the stent in place as shown in FIG. 44.

This appliance would also be useful as a “band-aid” for the public when they burn their palate eating hot food.

### Palatal Obturator:

A palatal obturator is a prosthetic appliance that covers an opening in the palate that leads to the nasal cavity. It is basically a plastic, removable retainer which aids in speech, eating and proper airflow. In some cases, the appliance needs to be altered in shape as healing or surgery occurs. Examples of patients needing a palatal obturator are people with cleft palates, those who have had tumors removed and those that have had traumatic injuries to their palate.

Fabrication:

1. Pre-form a tray over the generic upper arch model

2. Trim the tray to the middle of the biting surfaces extending up to the handle area. (Handle or no handle)

3. Place 1 mm to 1.5 mm layer of thermoplastic material on the tray ending approximately 3 mm inside tray edge.

Customization:

4. Heat the tray or lining unit in hot water (140-170° F.).

5. Place in mouth and adapt to palate with fingers and tongue.

6. Hold unit in place with tongue until plastic sets.

7. Remove the unit from the mouth and peel off tray.

8. Trim off all plastic that covers the biting surfaces.

9. For palatal obturator, add thermoplastic as needed to close void on palate.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of direct intraoral fabrication of an oral device, the method comprising:
placing pliable unset plastic material on a flexible preformed tray having at least one functional component incorporated therein;
adapting intraorally the pliable unset plastic on the tray to the upper palate; and allowing the plastic to harden.

2. The method of claim 1, comprising an initial step of forming the flexible tray to include the at least one functional component.

3. The method of claim 2, comprising the further step of trimming the hardened plastic material away from biting surfaces of the teeth.

4. The method of claim 2, comprising the further step of trimming hardened plastic material that extends beyond biting surfaces of the teeth.

5. The method of claim 4 wherein trimming comprises trimming the hardened thermoplastic material away from biting surfaces of the teeth.

6. The method of claim 2 wherein the functional components comprise at least one from among an anterior deprogrammer, a partial coverage occlusal guard, a full coverage occlusal guard, a full contact permissive guard, a palatal obturator, a surgical healing stent, and a palatal retainer.

7. The method of claim 1, comprising the step of heating a thermoplastic material to the point it becomes pliable prior to adapting it intraorally, on the flexible preformed tray, to the upper palate.

8. The method of claim 7, comprising heating the thermoplastic material in water having a temperature in the range of 140 degrees Fahrenheit to and including 170 degrees Fahrenheit.

9. A device for use with a user's teeth, comprising:
a hardened thermoplastic palatal retainer and at least one other functional component incorporated on the palatal retainer, the palatal retainer formed on the user's palate with the user's tongue and fingers to fit the palate and selected teeth in the user's mouth.

10. The device of claim 9 wherein the functional components comprise at least one from among an anterior deprogrammer, a partial coverage occlusal guard, a full coverage occlusal guard, a full contact permissive guard, a palatal obturator, a surgical healing stent, and a palatal retainer.

11. A kit, comprising:
a preformed flexible tray;
an unset plastic palatal blank on the tray; and
at least one functional component in additional to the palatal blank on the tray.

12. The kit of claim 11 wherein the functional component comprises at least one from among an anterior deprogrammer, a partial coverage occlusal guard, a full coverage occlusal guard, a full contact permissive guard, a palatal obturator, a surgical healing stent, and a palatal retainer.

13. The kit of claim 11 wherein the palatal blank is formed of thermoplastic material that becomes pliable when heated in water having a temperature in the range of 140 degrees Fahrenheit to and including 170 degrees Fahrenheit.

14. A kit, comprising a preformed flexible tray with a palatal blank that will result in either a palatal obturator or a healing stent when used.

15. The kit of claim 14 wherein the palatal blank is formed of thermoplastic material that becomes pliable when heated in water having a temperature in the range of 140 degrees Fahrenheit to and including 170 degrees Fahrenheit.

16. A method of direct intraoral fabrication of an anterior discluder device for fitting to the upper palate and corresponding teeth, the method comprising:
forming a tray to cover the upper palate and the teeth of the upper palate;
placing pliable thermoplastic material on the tray;
adapting intraorally the pliable thermoplastic on the tray to the upper palate;
allowing the thermoplastic to harden;
trimming the hardened thermoplastic material of posterior biting surfaces; and
adding a discluding element to the lingual side of the central incisors.

17. The method of claim 16, comprising trimming the hardened thermoplastic material away from the biting surfaces of the back teeth.

18. The method of claim 16, wherein adding the discluding element to the lingual side of the central incisors comprises forming the discluding element with the user's tongue.

19. The method of claim 16, further comprising wrapping the discluding element to a facial surface of the anterior teeth for retention.
